(19) United States
(12) Patent Application Publication
(10) Pub. No.: US 2014/0272272 A1
(43) Pub. Date: Sep. 18, 2014

(54) ELECTROSTATIC DRY ADHESIVES

(71) Applicants: Matthew Spenko, Chicago, IL (US); Donald Ruffatto, III, New Lenox, IL (US)

(72) Inventors: Matthew Spenko, Chicago, IL (US); Donald Ruffatto, III, New Lenox, IL (US)

(21) Appl. No.: 14/207,989

(22) Filed: Mar. 13, 2014

Related U.S. Application Data
(60) Provisional application No. 61/787,816, filed on Mar. 15, 2013.

(51) Int. Cl. C09J 9/00; B32B 37/24

(52) U.S. Cl. CPC C09J 9/00; B32B 37/24
USPC 428/113; 156/245; 428/172

(57) ABSTRACT

Electrostatic dry adhesive devices having a microstructured dry adhesive element formed directly into a contact surface of an electrostatic adhesive. The microstructured dry adhesive element, such as in the form of microwedges, can be molded into surface of an electrostatic adhesive. Also provided are associated methods of making such adhesive devices.

### CROSS REFERENCE TO RELATED APPLICATION

This application claims the benefit of U.S. Provisional. Application Ser. No. 61/787,816, filed on 15 Mar. 2013. The co-pending Provisional patent application is hereby incorporated by reference herein in its entirety and is made a part hereof, including but not limited to those portions which specifically appear hereinafter.

### STATEMENT REGARDING FEDERALLY SPONSORED RESEARCH OR DEVELOPMENT

This invention was made with government support under grant N00014-10-1-0769 awarded by the Office of Naval Research and grant NNX11AN31H awarded by NASA. The government has certain rights in the invention.

### BACKGROUND OF THE INVENTION

1. Field of the Invention

This invention relates generally to adhesives.

2. Discussion of Related Art

Controllable (i.e., on-off) attachment mechanisms, such as suction, electromagnets, microspines, fibrillar (gecko-like) and electrostatic adhesives, are used in a wide variety of applications and each tend to perform well on specific types of surfaces. For example, suction and fibrillar adhesives tend to work well on smooth surfaces, microspines tend to work well on rough surfaces and magnets tend to work well on ferromagnetic surfaces. However, each of these different types of adhesives generally fails when applied to a different surface type. For instance, suction tends to fail on porous or rough surfaces and microspines cannot or do not generally adhere well to smooth surfaces.

Various manufacturing lines commonly use suction-based systems to perform pick and place operations for manipulation, assembly and palletization. While widely used, these systems have several drawbacks including the need for support equipment such as compressors and tubing, on/off lag time on the order of several seconds, and limited ability to grip porous or rough surfaces.

In an effort to get mobile robots to climb vertical surfaces, researchers have employed almost every type of controllable adhesive, including magnets, suction, microspines, gecko-like fibrillar dry adhesives and electroadhesives. Similar work has been undertaken in the area of perching micro air vehicles on walls and ceilings. However, these types of robots are not widely deployed in the field owing to the simple fact that in most situations, an operator does not have prior knowledge of the surface with which the robot will interact.

FIG. 1 illustrates a conventional electrostatic adhesive, generally designated by the reference numeral 110. The electrostatic adhesive 110 includes two electrodes, 112 and 114, respectively, separated from a substrate 116 and each other by a dielectric material layer 120. By creating a voltage potential between the two electrodes, an electrostatic field is generated. The electrostatic field polarizes the surface and creates an adhesive force. This or related technology has been used for robotic grippers in the semi-conductor industry since the 1990's. It has also been used successfully on a robot capable of climbing a very wide range of surfaces.

An advantage of electrostatic adhesion is that it can be used on various surfaces, e.g., conducting, semi-conducting, or insulating, and although it requires continuous power to remain attached to the wall, the power draw is relatively low. A disadvantage of electrostatic adhesion, however, is the relatively low adhesion force resulting or produced therewith or thereby, especially when compared to suction or electromagnetic adhesion.

The adhesive force generated by electrostatic adhesion for a conductive substrate is given as:

$$F = \frac{A ɛ {V}^{2}}{2 {d}^{2}} \qquad ( 1 )$$

where;

A is the contact area,

∈ is the dielectric permittivity,

V is the applied voltage (typically in the kV range), and

d is the dielectric thickness.

To optimize such a system, the applied voltage, permittivity, and real area of contact preferably are high, while the dielectric layer is preferably thin. In addition to the dielectric layer being thin, the distance from the electrode to the substrate preferably is as small as possible. Previous devices that have used electrostatic adhesion have typically focused on attachment to flat surfaces, and thus the substrate is touching the dielectric layer such that the distance between the substrate and electrodes is as small as possible. Such placement or disposition is generally not possible on rough and/or undulating surfaces, and thus such applications require the use of other mechanisms to ensure that the substrate/electrode distance is minimal.

Various patent documents, including: U.S. Pat. No. 7,872,850; U.S. Pat. No. 7,551,419; U.S. Pat. No. 7,934,575; and US 2010/0271746, at least in part relate to electrostatic adhesives:

Microstructured adhesives (also referred to as dry adhesives), such as are typically modeled on gecko feet, have received significant attention recently. For example, how geckos adhere to walls has been a subject of scientific dispute for many years; however, in the early 2000's researchers discovered that van der Waals forces are the primary contributor. This discovery, coupled with improved microscopic imaging and microscale fabrication capabilities, kicked off a still-growing field of the design and manufacture of synthetic directional dry adhesives. Like the features on the toes of gecko lizards, directional dry adhesives commonly use asymmetric microstructured hairs that create a high real area of contact when loaded in a preferred direction. When the load is reversed, the adhesives release from the surface with near zero force. This property allows geckos to quickly attach and detach their feet when climbing walls.

Dry adhesion relies on intermolecular van der Waals forces, which vary inversely as a function of the square of the distance between two molecules. Van der Waals forces are the underlying phenomenon of most forms of adhesion. For example, adhesive tape creates a large real area of contact between its backing and the surface. Such adhesion is achieved by the adhesive layer, which effectively flows between the substrate and the backing, thus reducing the intermolecular distances.

With dry adhesion, two surfaces must obtain a large real area of contact without the benefit of a liquid medium. Geckos use this principle through a compliant hierarchical array of β-keratin structures that end in very small (on the order of a few nanometers) spatular tips. This hierarchical compliance allows the spatular tips to come into extremely close contact with the substrate. Although the resultant force is small, the large number of spatulae in contact with the surface generates an appreciable net force.

While synthetic directional dry adhesives have yet to match the performance of live geckos, significant progress has been in attempts to synthesize them.

In general, synthetic gecko-like adhesives can be categorized into three types: submicrometer structures, isotropic microstructures and anisotropic microstructures

Fibrillar submicrometer structures can generally show high levels of adhesion, but since the fibers lack a directional preference, they are generally sticky in all directions and cannot be detached from surfaces easily or efficiently. Owing to the relationship between fiber size and real area of contact, these submicrometer fibers can often be made of much stiffer materials, for example carbon nanotubes. Isotropic microstructures often use unique geometries at the tips of the fibers to increase the adhesion, for example mushroom-shaped caps. The performance of various tip shapes has been characterized in previous work as showing that the mushroom shape enhances adhesion by several fold over a flat tip shape. Finally, anisotropic microstructures use the directional preference of the adhesive's shape, similar to the structures on a gecko toe, to turn adhesion on and off easily.

Dry adhesives have many benefits with theoretically few drawbacks. Dry adhesives are generally controllable, work on smooth and rough surfaces, have a low attachment force, and operate in dirty and wet environments. Several climbing robots have used some form of dry adhesion. However, even with the large body of research devoted to developing synthetic dry adhesion, these adhesives have been limited to smooth surfaces due to manufacturing difficulties.

Various patent documents, including: U.S. Pat. No. 7,811,272; US 2008/0023439 A1; US 2005/0271870 A1; US 2008/0280085 A1; US 2010/0021647 A1; U.S. Pat. No. 7,695,811; U.S. Pat. No. 7,762,362; U.S. Pat. No. 7,785,422, and US 2006/0078725 A1 at least in part relate to directional dry adhesives or at least dry adhesives.

Thus, there is a need and a demand for adhesive devices and associated adhesive techniques or processes whereby various of the above-identified shortcomings of prior adhesives and attachment mechanisms can at least in part be reduced or minimized and preferably avoided.

For example, there is a need and a demand for an adhesive technology that desirably extends the range of substrate materials and roughness to which controllable adhesives can be applied. Further, there is a need and a demand for an adhesive that can operate on smooth, micro-rough, curved, flat, conductive and non-conductive surfaces alike.

### SUMMARY OF THE INVENTION

A general object of the invention is to provide an improved adhesive device.

A more specific objective of the invention is to provide an adhesive device that reduces, minimizes, or overcomes one or more of the problems described above.

One aspect of the invention relates to an adhesive device, material or product that desirably combines features or beneficial aspects of both dry adhesives and electrostatic adhesives. For example, the resulting product, as compared to conventional dry adhesives, can greatly expand the range of surface materials and roughnesses upon which the adhesive is effective and, as compared to conventional electrostatic adhesives, greatly enhance adhesion levels.

Accordingly, the general object of the invention can be attained, at least in part, through an adhesive device having or including a microstructured dry adhesive element formed directly onto a contact surface of an electrostatic adhesive.

In accordance with certain specific embodiments, an array of adhesive microstructure features, such as in the form of microwedges, for example, can be desirably formed in an adhesive outer surface of the dry adhesive element.

An adhesive device in accordance with one particular embodiment includes a dry adhesive element having microwedges molded into a contact surface of an electrostatic adhesive comprising conductive electrodes embedded in a moldable polymer.

In another aspect of the invention, there is provided a new manufacturing process for making an electrostatic dry adhesive. In accordance with one embodiment, such a method involves coating a moldable polymer onto a mold of a dry adhesive. A second layer of the moldable polymer is applied onto the moldable polymer coating. A conductive mesh containing an electrode pattern is embedded in the second layer of the moldable polymer. A third layer of the moldable polymer is subsequently applied on top of the second layer such as to encapsulate the conductive mesh to form an electrostatic dry adhesive precursor. The electrostatic dry adhesive precursor is cured to create the electrostatic dry adhesive.

As used herein, the term “electrostatic dry adhesives” or “FDA” generally refers to the subject new adhesive device, material or product that desirably combines features or beneficial aspects of both dry adhesives and electrostatic adhesives.

Other objects and advantages will be apparent to those skilled in the art from the following detailed description taken in conjunction with the appended claims and drawings.

### BRIEF DESCRIPTION OF THE DRAWINGS

FIG. 1 is a schematic representation of a conventional electrostatic adhesive.

FIG. 2 shows an electrostatic dry adhesive in accordance with one embodiment of the invention.

FIG. 2(a) and FIG. 2(b) are magnified photographs of the gecko-like dry adhesion-providing microstructure(s) of the electrostatic dry adhesive shown in FIG. 2.

FIG. 3 is a simplified schematic cross-sectional view of an electrostatic dry adhesive in accordance with one aspect of the invention.

FIG. 4 is a schematic diagram of an electrostatic directional dry adhesive in accordance with one aspect of the invention.

FIG. 5(a)-FIG. 5(d) are simplified sequential cross-sectional views depicting a manufacturing process to produce an electrostatic dry adhesive in accordance with one embodiment of the invention.

FIG. 6(a)-FIG. 6(d) illustrate several of the possible electrode geometries that can be used in the practice of the invention.

FIG. 7 is a photograph showing a test platform used in obtaining the test results shown in the TABLE 1, below.

FIG. 8 is a graphical presentation of shear stress as a function of surface roughness for the four different adhesive technologies obtained in the testing in the Examples below.

FIG. 9 is a bar chart showing the shear stress generated on the three roughest substrates from FIG. 8.

### DESCRIPTION OF PREFERRED EMBODIMENTS

As detailed further below, the present invention provides an adhesive device, material or product, termed an electrostatic dry adhesive (EDA), that desirably combines features or beneficial aspects of both dry adhesives and electrostatic adhesives. FDA's are discussed, described and further detailed in the article of the Journal of the Royal Society Interface entitled, “Improving controllable adhesion on both rough and smooth surfaces with a hybrid electrostatic/gecko-like adhesive”, J. R. Soc. Interface 2014 11, 20131089, published 22 Jan. 2014, and whose disclosure is hereby incorporated by reference herein and made a part hereof, including but not limited to those portions which specifically appear hereinafter.

In accordance with one aspect of the invention, a subject device is desirably fabricated at least in part from a moldable polymer. This material allows the device to more closely conform to the surface of the substrate. This is especially useful on rough and undulating surfaces. Further, it reduces the distance between the electrodes and the substrate, which increases the adhesion force. Furthermore, it increases the coefficient of friction, which raises the shear adhesion force.

Moreover, by using a moldable polymer, the polymer can desirably be doped with particles to modify the dielectric properties of the adhesive pad. Doping generally increases the dielectric permittivity (see Equation 1), which increases the adhesion force. For example, suitable particles that can be used for such doping but are not necessarily limited to: barium titanium oxide, a high dielectric constant material, as well as nickel-coated graphite, and copper. It is believed that the inclusion of such doping particles in a moldable polymer such as silicone can act or serve to increase the dielectric constant of the material and thus enhance the electric field strength.

In accordance with another aspect of the invention, electrostatic adhesives have been fabricated using an etching technique with conductive fabrics. The addition of a fabric layer can help distribute the load throughout the adhesive pad. By combining a fabric layer with an electrostatic layer, the benefits of a fabric can be realized without unduly increasing the thickness, and thus the bending stiffness, of the adhesive pad.

FIG. 2 shows an electrostatic dry adhesive, generally designated by the reference numeral 210, in accordance with one embodiment of the invention. The electrostatic dry adhesive 210 is a novel adhesive that combines the properties of electrostatic and gecko-like dry adhesives (see FIG. 2(a) and FIG. 2(b)) to create an adhesive that can operate on smooth, micro-rough, curved, flat, conductive and non-conductive surfaces alike. In fact, on rough surfaces, the adhesive often outperforms the sum of its individual parts.

Efforts have led to the fabrication of arrays of anisotropic microstructures that have many gecko-like properties including directional adhesion (on-off behavior) and high reusability. In one embodiment, the microstructures are or consist of angled fibers such as are 20 μm at the base, 60-70 μm tall and 200 μm wide with a space of 20 μm between each fiber. When shear is applied in the preferential direction, these wedge-shaped fibers bend over, dramatically increasing the real area of contact and generating high levels of adhesion through van der Waals interactions. However, when this shear is released or not applied in the preferred direction, the fibers do not engage the surface and adhesion is negligible.

These fibers are fabricated in batches using a molding process. Molds are made from SU-8 using a two-step angled lithography procedure and silicone rubber is used as the casting material. The molds are reusable, so after its initial fabrication many sheets of gecko-like adhesive can be cast with relative ease. The microwedges can advantageously be directly molded into the pad surface using a wax mold cast from an SU-8 master mold. In such practice, a wax mold can advantageously be used to reduce the demolding force and thus the internal peeling forces included on the adhesive.

Those skilled in the art and guided by the teachings herein provided, however, will understand and appreciate that the broader practice of the invention is not necessarily limited to microstructures of such dimensions or to microstructures of such shape or form. Thus, it is to be understood that, if desired, the invention can be practiced with such microstructures of different dimensions as well as microstructures of different shape and form.

Turning to FIG. 3, there is illustrated an electrostatic dry adhesive device 310, in accordance with one aspect of the invention. In the electrostatic dry adhesive device 310, microstructured dry adhesive elements 312, such as in the form of microwedges, are formed directly, such as by being molded, into the silicone polymer contact surface 314 behind which a set of electrostatic adhesive electrodes 316 are embedded in silicone polymer 318. In the electrostatic dry adhesive device 310, the electrostatic adhesive is able to provide a normal adhesion force to preload the dry adhesive element 312 and pull the EDA 310 onto a substrate for excellent surface conformation. The directional dry adhesive 312 desirably provides conformation to micro scale features, easy release properties and a high real area of contact. Owing to this, the electrostatic dry adhesive 310 demonstrates enhanced performance over a wide range of substrate materials and roughness. This greatly extends the operating envelope of electrostatic dry adhesives in comparison to other adhesive technologies.

For an electrostatic dry adhesive device in accordance with one preferred embodiment of the invention, a gecko-like adhesive, termed microwedges, are molded directly into the contact surface behind which are embedded a set of electrostatic adhesive electrodes.

FIG. 4 is a diagram presentation of an electrostatic directional dry adhesive, generally designated by the reference numeral 410, in accordance with one aspect of the invention.

The electrostatic directional dry adhesive 410 generally includes or is composed of dry adhesives 412, electrodes 414, silicone 416 and “Curved DPS” 418. As used herein the term “Curved DPS” generally refers to curved directional polymer stalks, another name for dry adhesives. If desired, such a backing layer, for example, can be used and included to enhance the adhesive strength on rough surfaces. It is to be understood, however, that the broader practice of the invention is not necessarily limited to the inclusion and use of such a backing layer. Moreover, the lengths depicted in FIG. 4 are for representative purposes only and do not necessarily form a limitation on the broader practice of the invention.

FIG. 5(a)-FIG. 5(d) illustrate or depict a multi-step manufacturing process to produce an electrostatic dry adhesive 510 in accordance with one embodiment of the invention.

More specifically, as shown in FIG. 5(a), a thin layer of dry adhesive material 512, e.g., Shore 40A silicone rubber, has been spun coated onto a suitable, e.g., 75 mm diameter, wax mold 514 of dry adhesive. FIG. 5(b) shows a second layer 516 of the silicone rubber has been spun coated on top of the first layer 512 and an electrode pattern 520 has been gently embedded therein. FIG. 5(c) shows a third, final layer 522 of the silicone rubber has been spun coated on top of the second layer 516 and to encapsulate the electrodes 520 and then allowed to cure. FIG. 5(d) shows the EDA 510 has been removed from the wax mold.

FIG. 6(a)-FIG. 6(d) illustrate several of the possible electrode geometries that can be used in the practice of the invention, including: FIG. 6(a) concentric circles; FIG. 6(b) square spiral; FIG. 6(c) Hilbert curve; and FIG. 6(d) comb. It is to be understood, however, that the broader practice of the invention is not necessarily limited to use with a specific or particular electrode geometry as other electrode geometries useable in the practice of the invention will be apparent to those skilled in the art and guided by the teachings herein provided.

The EDAs of the invention work well on such a variety of surfaces as through the practice of the invention the technologies of electrostatic adhesion and gecko-like dry adhesion act or serve to complement each other. Electrostatic adhesion uses a set of conductive electrodes deposited inside a dielectric. Applying a high voltage potential across the electrodes generates an electric field, which creates an adhesive force on both conductive and non-conductive substrates. Dry adhesives, which are modeled on gecko feet, rely on intermolecular van der Waals forces and require a large number of very small fibrillar structures to make contact with the surface. This creates a micro-structure that is resistant to crack propagation and whose normal adhesion levels can be controlled by applying an appropriate amount of shear force. The combination in the invention creates a positive feedback cycle whose whole is often greater than the sum of its parts. The directional dry adhesive can physically bring the electrostatic adhesive closer to the surface, which helps the electrostatic adhesive generate more adhesion. Consequently, the electrostatic adhesion helps engage more of the directional dry adhesive stalks, especially on rough surfaces.

As will be appreciated the hybrid electrostatic/dry adhesive (EDA) of the invention can offer many benefits in a wide variety of applications that range from manufacturing to mobile robots that climb vertical and inverted surfaces to satellite grappling in space.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

The making of an electrostatic dry adhesive in accordance with one embodiment of the invention involved embedding a set of conductive electrodes inside a dry adhesive such as Shore 40A platinum cure silicone rubber, Plat-Sil 73-40, from Polytek Development Corp. A conductive mesh such as composed of a 51 threads cm⁻¹ polyester weave with a copper-nickel coating, which yields a resistivity of less than 0.015 cm⁻² was used for forming the electrode(s). An electrode pattern was chemically etched into the mesh material by clamping the mesh in a mold and immersing it in a ferric chloride solution to remove the conductive coating from unwanted regions. After 4 min, the mesh was removed from the etching solution, thoroughly cleaned with acetone and wires are soldered on. In addition to providing the electrodes, the conductive mesh allows for distribution of shear loads across the pad and can be a critical feature of the design.

The fabrication process for the EDA consists of the multiple step procedure shown in FIG. 5(a)-FIG. 5(d), described above. As shown in FIG. 5(a), a thin, approximately 150 μm, layer of silicone was spun onto a directional dry adhesive mold at 1200 r.p.m. The silicone was allowed to partially cure in an oven at 45° C. for 15 min. Then a second layer was spun coated at the same speed (step h), and a conductive mesh containing the electrode pattern was embedded into the uncured silicone. The silicone was again allowed to partially cure at the same temperature for 10 min. In step (c), a final layer of silicone was spun coated on top of the second layer at the same speed to completely encapsulate the conductive mesh. The final EDA was fully cured in an oven at 75° C. for 30 min. The EDA was then removed from the wax mold. This manufacture resulted in an EDA that was approximately 500 mm thick, 48 mm in diameter and with an adhesive area of 18 cm².

In addition to the EDA pads, comparative fiber-reinforced PDMS, electrostatic and directional dry adhesives with the same diameter, thickness and material were manufactured to serve as controls in the experiments. The fiber-reinforced PDMS and electrostatic samples were fabricated. The dry adhesive control was evaluated by testing an EDA with the electrostatic element in its ‘off’ state. These were chosen as controls for two reasons: (i) to isolate the effects of individual technologies and (ii) ability to be fabricated via the same general manufacturing process. The latter allowed all the pads to possess the same mechanical properties such as stiffness and tear strength. Three samples were manufactured for each type of adhesive.

A range of experiments were performed to quantify the adhesion enhancements realizable through the use of the EDA. The tested substrate materials, experimental set-up and test procedure are described below.

### Experimental Set-Up

A test platform including a 6-DOF force-torque sensor and a pneumatic air slide actuated through a variable pressure regulator evaluated the shear performance of the different adhesive technologies (see FIG. 7). The substrate was mounted directly to a force-torque sensor while the adhesive was mounted to an air slide oriented parallel to the substrate.

A simple test sequence detached the adhesive from the substrate to generate shear force data as follows:
(1) the air slide was shifted forward and the adhesive was gently laid onto the substrate material (no preload was applied);
(2) if needed, a 5 kV DC/DC converter (EMCO Q Series) energized the electrostatic adhesive and a 10 s delay was observed;
(3) the variable pressure regulator increased the force output of the air slide until the adhesive detached from the substrate;
(4) force data was recorded from the 6-DOF force-torque sensor at 1 kHz using a National Instruments data acquisition board and LabVIEW:
(5) a third-order Butterworth filter with a cut-off frequency of 10 Hz was used to remove any unrepresentative load spikes caused by dynamic effects; and
(6) the peak shear force value was extracted and converted to a shear stress by dividing by the adhesive area, 18 cm².
   It is important to note that while the filter in step 5 reduces the maximum recorded adhesion levels, it is believed necessary to filter out high-frequency vibrations that occur from the pneumatic slide and noise from the force-torque sensor.

### Substrate Materials

Each adhesive was tested on a range of substrate materials to evaluate the adhesive's performance with respect to surface material type. The materials ranged from common household materials such as painted drywall, finished wood, glass and steel to more exotic space-grade materials, such as carbon fiber sandwich panel, graphite M55J, thermal black paint on aluminium, copper-clad Rogers 4003, white beta cloth, reinforced Kapton and reinforced Kapton MLI film. Additionally, each adhesive was tested on a set of ceramic tiles to evaluate the adhesive's performance with respect to surface roughness. Ceramic tiles were used because they possessed widely varying textures and roughness with the same underlying material. A total of 14 different tiles were selected and their surface roughness was measured using a profilometer (KLA-Tensor Alphastep 500). Measurements were taken along a 5 cm strip located at the center of the tile from which the arithmetic, RMS and peak-peak roughness were calculated. The tile samples exhibited a wide range of roughness values with RMS values ranging from 9 to 109 mm.

### Test Procedure

For each adhesive sample, a total of 10 trials were performed on each substrate material using the testing platform previously described. Before testing, each adhesive pad was thoroughly cleaned using masking tape to remove any dust or other contaminants. It was found that any residue left by the masking tape did not artificially increase the adhesive levels as compared with when the pads were first tested immediately after fabrication. The remaining trials were then run consecutively. The resulting data was checked for consistency to ensure that there are no cycle life related effects. This allowed for the shear force and shear stress values to be directly averaged for further analysis.

This testing procedure was used for all the experimental test results presented in TABLE 1, below.

TABLE 1

| | Attachment Mechanism (kPa) | | | |
|---|---|---|---|---|
| | Plain | Electrostatic | Dry | Hybrid |
| Material | Polymer | Adhesive | Adhesive | Adhesive |
| Rough Tile | 0.1 | 2.7 | 3.7 | 7.0 |
| Finished Wood | 41.6 | 45.9 | 39.8 | 42.8 |
| Drywall | 1.9 | 11.1 | 13.4 | 15.9 |
| Glass | 60.4 | 62.0 | 46.8 | 49.0 |
| 1018 steel | 34.8 | 36.0 | 32.1 | 35.2 |
| Unidirectional Carbon | 3.4 | 7.6 | 20.5 | 23.2 |
| Fiber Sandwich Panel | | | | |
| Rubberized Aluminum- | 0.1 | 5.8 | 6.2 | 7.9 |
| thermal black | | | | |
| Copper Clad Rogers | 8.7 | 13.2 | 113 | 11.7 |
| Thermal Blanket - white | 0.1 | 1.4 | 8.0 | 10.0 |
| beat cloth | | | | |
| Heat Shielding - Gold | 2.2 | 9.7 | 4.5 | 15.0 |
| reinforced Kapton MLI | | | | |
| film | | | | |
| Heat Shielding - Black | 0.7 | 2.4 | 1.7 | 6.6 |
| reinforced Kapton | | | | |

### Surface Roughness

Surface roughness has a direct effect on adhesive force. One of the primary advantages of the newly developed EDA is its ability to conform to surface irregularities and provide enhanced adhesion properties. To demonstrate this, tests were performed with all four adhesive technologies on 14 different ceramic tiles. For each adhesive, the peak shear stress with respect to the substrate RMS roughness is shown in FIG. 8.

As seen in FIG. 8, at relatively low levels of roughness (approx. less than 10 μm), all the adhesive technologies tend to show similar performance. While the vast majority of previous research has investigated smooth surfaces, the focus here with EDA's is predominately performance of these adhesives on rough surfaces.

On what is herein considered to be smooth tile surfaces, loosely categorized as possessing an RMS roughness of less than 25 μm, the reinforced PDMS quickly demonstrated reduced performance in some instances. The hybrid EDA, microwedges and the electrostatic adhesive continued to perform approximately the same at these levels of roughness. Some of the tile samples had a low surface RMS value but larger macro surface features that are not accounted for in the roughness measurement. On these surfaces, the reinforced PDMS performed poorly believed due to its inability to conform to the macro scale surface features. By contrast, the electrostatic adhesive is able to generate a normal force and the microwedge features on the dry adhesive provide natural compliance and pull the adhesive into the substrate as the stalks engage.

On rough surfaces, the EDA showed the greatest performance improvements (see FIG. 8). In these examples, the shear stress achievable using a hybrid EDA was greater than the sum of that achieved by the electrostatic and directional dry adhesives alone. FIG. 9 shows that this was the case for the tiles with high surface roughness; greater than around 50 μm RMS. This is most likely due to the two technologies' ability to directly complement each other. The electrostatic adhesive is capable of generating a normal force, which draws the pad into the substrate. This allows the dry adhesive microwedges to gain improved surface contact and engagement. As more of the microwedge features are loaded, they pull the pad closer to the substrate surface. When this occurs, the conductive electrostatic electrodes are also moved closer to the substrate, thus increasing their normal force. This creates a positive feedback loop that allows each technology to improve the other's adhesion capability. Therefore, the subject EDA can maintain a high effectiveness even on rough surfaces, thus greatly expanding its operational envelope.

It is important to note the local maxima that can be seen in FIG. 8 and FIG. 9 at a roughness of 92.7 μm RMS. This seems to be counterintuitive, as it is expected that there would be correspondingly lower shear forces as the substrate RIMS increases. Upon further inspection, this can be attributed to the difficulty in characterizing roughness as a single value. The flexible nature and compliance of the EDA and controls appear to conform to low frequency roughness better than high frequency. This ultimately reduces the real contact area and thus shear stress.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An adhesive device comprising:
a microstructured dry adhesive element formed directly into a contact surface of an electrostatic adhesive.

2. The adhesive device of claim 1 comprising the microstructured dry adhesive element molded directly into a contact surface of an electrostatic adhesive.

3. The adhesive device of claim 1 comprising a moldable polymer material.

4. The adhesive device of claim 1 wherein an array of adhesive microstructure features is formed in an adhesive outer surface of the dry adhesive element.

5. The adhesive device of claim 4 wherein the adhesive microstructure features comprise microwedges.

6. The adhesive device of claim 5 wherein the microwedges comprise:
an array of longitudinally spaced fibers.

7. The adhesive device of claim 5 wherein the microwedges comprise:
an array of longitudinally spaced angled fibers.

8. The adhesive device of claim 1 comprising:
conductive electrodes embedded in a moldable polymer.

9. The adhesive device of claim 8 wherein the moldable polymer comprises a silicone rubber.

10. The adhesive device of claim 8 additionally comprising dopant particles in the polymer to increase adhesion force.

11. The adhesive device of claim 8 wherein at least one electrode comprises a conductive mesh or fabric.

12. The adhesive device of claim 11 wherein at least one electrode comprises an etched conductive mesh or fabric.

13. The adhesive device of claim 12 wherein the conductive mesh or fabric comprises a polyester weave with a selective copper-nickel coating.

14. The adhesive device of claim 1 additionally comprising a backing layer.

15. An adhesive device comprising:
a dry adhesive element having microwedges molded into a contact surface of an electrostatic adhesive comprising at least one conductive electrode embedded in a moldable polymer.

16. The adhesive device of claim 15 wherein the microwedges comprise an array of longitudinally spaced angled fibers.

17. The adhesive device of claim 15 wherein the moldable polymer comprises a silicone rubber.

18. The adhesive device of claim 15 wherein said at least one electrode comprises a conductive mesh or fabric.

19. The adhesive device of claim 18 wherein the conductive mesh or fabric comprises a polyester weave with a selective copper-nickel coating.

20. A method of making an electrostatic dry adhesive, the method comprising:
coating a moldable polymer onto a mold of a dry adhesive,
applying a second layer of the moldable polymer onto the moldable polymer coating and embedding electrodes in the second layer of the moldable polymer,
applying a third layer of the moldable polymer on top of the second layer to completely encapsulate the conductive mesh to form an electrostatic dry adhesive precursor and
finally curing the curing the electrostatic dry adhesive precursor to create the electrostatic dry adhesive.

21. The method of claim 20 wherein microwedges are formed in the moldable polymer and wherein the electrodes embedded in the second layer of the moldable polymer comprise a conductive mesh containing an electrode pattern.
